(19) United States
(12) Patent Application Publication
(10) Pub. No.: US 2011/0261987 A1
(43) Pub. Date: Oct. 27, 2011

(54) Condenser Microphone

(75) Inventors: Kensuke Nakanishi, Fukuoka (JP); Ryuji Awamura, Fukuoka (JP)

(73) Assignee: HOSIDEN CORPORATION, Yao-shi, Osaka (JP)

(21) Appl. No.: 12/675,021

(22) PCT Filed: Jul. 25, 2008
(86) PCT No.: PCT/JP2008/063433

§ 371 Date: May 3, 2010

(30) Foreign Application Priority Data
Sep. 10, 2007 (JP) 2007-234168

(51) Int. Cl. H04R 11/04

(52) U.S. Cl. 381/355

(57) ABSTRACT

A condenser microphone includes a housing (7) formed by combining: a top face member (15) as a top face; a bottom face member (5) as a bottom face; and intermediate members (13,14) disposed between the top face member (15) and the bottom face member (5). In the top face member (15) or the bottom face member (5), sonic holes (15a,15b) configured to allow a sound to enter an internal space is provided, and the internal space of the housing (7) is partitioned into a space extending from the sonic hole (15a) to one face of a vibrating membrane electrode (9) and a space extending from the sonic hole (15b) to the other face of the vibrating membrane electrode (9).

### TECHNICAL FIELD

The present invention relates to a condenser microphone, and particularly to a condenser microphone having, inside a housing, a vibrating membrane electrode configured to vibrate in response to sound waves entered an internal space of the housing and a fixed electrode, the condenser microphone including: a capacitor portion formed of the vibrating membrane electrode and the fixed electrode; a converting circuit portion configured to convert a change in capacitance of the capacitor portion into an electrical signal and to output the signal; and a conduction portion configured to allow electrical conduction between the capacitor portion and the converting circuit portion.

### BACKGROUND ART

As a microphone mounted inside an audio device, such as microphone device and mobile phone, there can be mentioned a condenser microphone having, inside a housing, a vibrating membrane electrode which vibrates in response to a sound entered an internal space of the housing and a fixed electrode, the condenser microphone including: a capacitor portion formed of the vibrating membrane electrode, the fixed electrode and an electret film which is formed on either of the electrodes: a converting circuit portion for converting a change in capacitance of the capacitor portion into an electrical signal and outputting the signal; and a conduction portion for allowing electrical conduction between the capacitor portion and the converting circuit portion. Optionally, such a condenser microphone may be imparted with directionality.

In the condenser microphone described in Patent Document 1, the housing uses a capsule member having an opening oriented in only one direction, and by covering the opening with a substrate, an enclosed space is created. A sonic hole for introducing sound waves to the inside of the housing is formed in each of the capsule member and the substrate. The capacitor portion is provided in the internal space of the housing so as to cover the sonic hole formed in the substrate from inside the housing. Accordingly, the sound waves entered the internal space of the housing from the sonic hole formed in the substrate reach one face of the vibrating membrane electrode of the capacitor portion covering the sonic hole. On the other hand, the sound waves entered the internal space of the housing from the sonic hole formed in the capsule member reach the other face of the vibrating membrane electrode of the capacitor portion.

In other words, the condenser microphone is configured in such a manner that one face of the vibrating membrane electrode accommodated in the housing receives the sound waves passed through the sonic hole formed in the substrate while the other face of the vibrating membrane electrode receives the sound waves passed through the sonic hole formed in the capsule member. In addition, the sonic hole formed in the capsule member is provided with an acoustic resistance body which imparts resistance to the sound waves passing through the sonic hole. Accordingly, the condenser microphone Patent Document 1 serves as a unidirectional condenser microphone that has a directional axis lying on a straight line connecting the sonic hole formed in the substrate and the sonic hole formed in the capsule member, and has directionality toward the sonic hole formed in the substrate.
Patent Document 1: JP2007-60661A

### DISCLOSURE OF THE INVENTION

When a condenser microphone is mounted inside an audio device, such as microphone device and mobile phone, in order to excellently detect a sound from outside the audio device, two sonic holes thereof have to communicate with the outside of the audio device. The condenser microphone described in Patent Document 1 has the sonic holes in the top face member (i.e., capsule member) and the bottom face member (i.e., substrate) of the housing: in other words, two sonic holes are oriented in the opposite direction. Therefore, it is necessary to allow sounds from outside the audio device to excellently enter two sonic holes oriented in the opposite direction, by elaborating the internal structure of the audio device. Accordingly, in the case of the condenser microphone described in Patent Document 1, in order to introduce sounds from outside the audio device to two sonic holes oriented in the opposite direction, design freedom of the audio device will be sacrificed.

The present invention has been made with the view toward solving the above-described problem, and the object is to provide a condenser microphone that has directionality, while securing design freedom of the audio device having the condenser microphone mounted therein.

In one aspect of the present invention for attaining the object described above, there is provided a condenser microphone having, inside a housing, a vibrating membrane electrode configured to vibrate in response to sound waves entered an internal space of the housing and a fixed electrode, the condenser microphone including: a capacitor portion formed of the vibrating membrane electrode and the fixed electrode; a converting circuit portion configured to convert a change in capacitance of the capacitor portion into an electrical signal and to output the signal; and a conduction portion configured to allow electrical conduction between the capacitor portion and the converting circuit portion, wherein the housing includes a combination of: a top face member forming a top face; a bottom face member forming a bottom face; and an intermediate member disposed between the top face member and the bottom face member; the top face member or the bottom face member is provided with a plurality of sonic holes configured to allow a sound to enter the internal space, and the internal space of the housing is partitioned into a space extending from one or more sonic holes among said plurality of the sonic holes to one face of the vibrating membrane electrode and a space extending from the other one or more sonic holes among said plurality of the sonic holes to the other face of the vibrating membrane electrode.

According to the configuration described above, sound waves emitted at a position equidistant from one or more of sonic holes among the plurality of the sonic holes and the other one or more sonic holes reach the top and bottom faces of the vibrating membrane electrode at substantially the same time. Therefore, a condenser microphone can be obtained in which sound waves emitted at a position equidistance from the above-mentioned one or more sonic holes and the above-mentioned other one or more sonic holes are cancelled at the vibrating membrane electrode. Accordingly, a bidirectional condenser microphone can be obtained that has a directional axis lying on a straight line connecting the sonic holes.

In addition, a plurality of the sonic holes can be formed in the same face of the housing unlike the conventional technique that necessitates sonic holes on both top and bottom faces of the housing, and thus design freedom of an audio device having this condenser microphone mounted therein will not be reduced.

Therefore, a condenser microphone can be provided that has directionality, while securing design freedom of the audio device having the condenser microphone mounted therein.

In another aspect of the condenser microphone according to the present invention, a covering member is attached to the housing so as to cover the top face member or the bottom face member provided with said plurality of the sonic holes, and each of said plurality of the sonic holes is provided with a vent passage from a lateral face of the housing to which the covering member is attached.

According to the configuration described above, sound waves are introduced to the internal space from the lateral face of the housing. Therefore, unlike the conventional techniques that necessitates sonic holes on both top and bottom faces of the housing, design freedom of an audio device having this condenser microphone mounted therein can be enhanced.

In another aspect of the condenser microphone according to the present invention, resistance means is provided which imparts resistance to sound waves passing through said other one or more sonic holes.

According to the configuration described above, sound waves emitted at a position closer to the above-mentioned other one or more sonic holes than the above-mentioned one or more sonic holes reach the top and bottom faces of the vibrating membrane electrode at substantially the same time, due to an effect of the resistance means. Therefore, a condenser microphone can be obtained in which sound waves emitted at a position closer to the above-mentioned other one or more sonic holes than the above-mentioned one or more sonic holes are cancelled at the vibrating membrane electrode. Accordingly, a unidirectional condenser microphone can be obtained that has directionality toward the above-mentioned one or more sonic holes.

In another aspect of the condenser microphone according to the present invention, the resistance means is formed by making a cross section of a passage of sound waves that pass through said other one or more sonic holes smaller.

According to the configuration described above, by reducing the size of the cross section of the passage of the sound waves that pass through the above-mentioned other one or more sonic holes, it takes a longer time for the sound waves passing through the above-mentioned other one or more sonic holes to reach the vibrating membrane electrode. Therefore, sound waves emitted at a position closer to the above-mentioned other one or more sonic holes than the above-mentioned one or more sonic holes reach the top and bottom faces of the vibrating membrane electrode at substantially the same time, due to an effect of the resistance means.

In another aspect of the condenser microphone according to the present invention, the resistance means is formed by making a passage of sound waves that pass through said other one or more sonic holes longer.

According to the configuration described above, by increasing the length of the passage of the sound waves that pass through the above-mentioned other one or more sonic holes, it takes a longer time for the sound waves passing through the above-mentioned other one or more sonic holes to reach the vibrating membrane electrode. Therefore, sound waves emitted at a position closer to the above-mentioned other one or more sonic holes than the above-mentioned one or more sonic holes reach the top and bottom faces of the vibrating membrane electrode at substantially the same time, due to an effect of the resistance means.

### BRIEF DESCRIPTION OF THE DRAWINGS

FIG. 1 is an exploded perspective view of a condenser microphone according to a first embodiment.

FIG. 2(a) is a cross section of the condenser microphone according to the first embodiment.

FIG. 2(b) is a top perspective view illustrating a state of a capacitor portion accommodated inside a housing.

FIG. 3 is an exploded perspective view of a condenser microphone according to a second embodiment.

FIG. 4(a) is a cross section of the condenser microphone according to the second embodiment.

FIG. 4(b) is a top perspective view illustrating a state of a capacitor portion accommodated inside a housing.

FIG. 5 is an exploded perspective view of a condenser microphone according to a third embodiment.

FIG. 6 is a partial perspective view of the condenser microphone according to the third embodiment seen from obliquely above.

FIG. 7 is an exploded perspective view of a condenser microphone according to a fourth embodiment.

FIG. 8 is a partial perspective view of the condenser microphone according to the fourth embodiment seen from obliquely above.

FIG. 9 is an exploded perspective view of a condenser microphone according to a fifth embodiment seen from a substrate side.

FIG. 10(a) is a cross section of the condenser microphone according to the fifth embodiment.

FIG. 10(b) is a bottom view of a substrate.

FIG. 11 is an exploded perspective view of a covering member and a portion of a substrate provided in a condenser microphone according to a sixth embodiment.

FIG. 12 is a cross section of the covering member and the portion of the substrate provided in the condenser microphone according to the sixth embodiment.

FIG. 13 is an exploded perspective view of a condenser microphone according to another embodiment.

FIG. 14(a) is a cross section of a condenser microphone according to another embodiment.

FIG. 14(b) is a top perspective view illustrating a state of a capacitor portion accommodated inside a housing.

FIG. 15 is an exploded perspective view of a covering member and a top face member of a condenser microphone according to still another embodiment.

FIG. 16 is an exploded perspective view of a covering member and a top face member of a condenser microphone according to still more another embodiment.

### BEST MODE FOR CARRYING OUT THE INVENTION

### First Embodiment

Hereinafter, with reference to the drawings, a condenser microphone according to a first embodiment will be described.

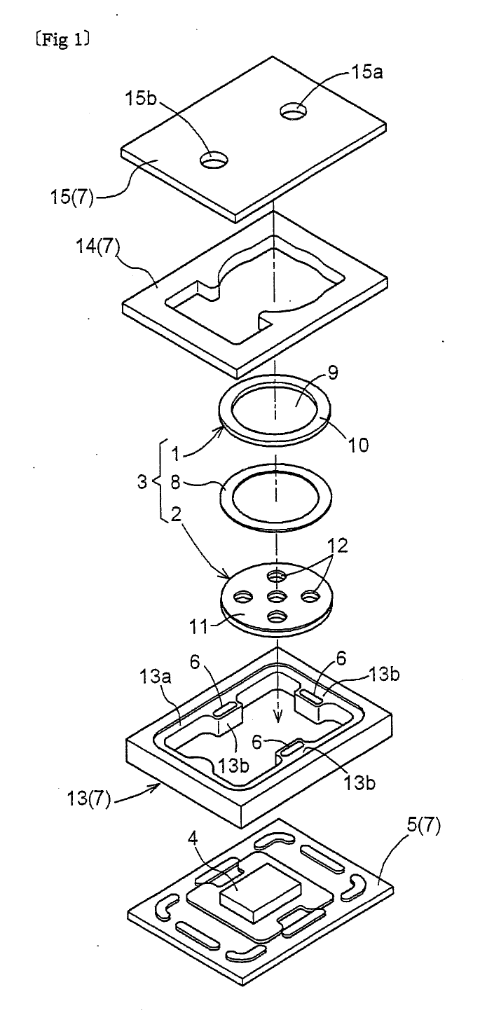

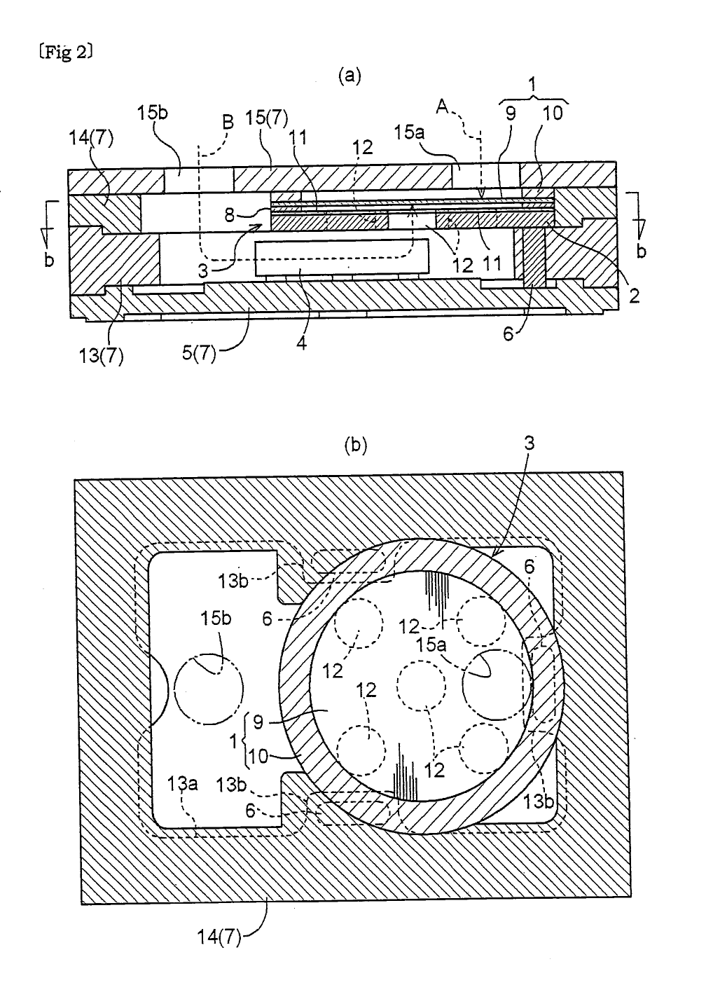

FIG. 1 is an exploded perspective view of the condenser microphone according to the first embodiment. FIG. 2(a) is a cross section of the condenser microphone according to the first embodiment. FIG. 2(b) is a top perspective view illustrating a state of a capacitor portion 3 accommodated inside a housing 7. The condenser microphone according to the first embodiment has, inside the housing 7, a vibrating membrane electrode 9 configured to vibrate in response to sound waves entered an internal space of the housing 7 and a back electrode plate 2 as fixed electrode, and includes the capacitor portion 3 formed of the vibrating membrane electrode 9 and the back electrode plate 2; a converting circuit portion 4 configured to convert a change in the capacitance of the capacitor portion 3 into an electrical signal and to output the signal; and a conduction portion 6 configured to allow electrical conduction between the capacitor portion 3 and the converting circuit portion 4.

The capacitor portion 3 is composed of a diaphragm 1, a ring-shaped spacer 8 and the back electrode plate 2, layered together. Specifically, the capacitor portion 3 includes the back electrode plate 2, the spacer 8 and the diaphragm 1, layered in this order from a substrate 5 side, and is formed as a capacitor by making a space between the diaphragm 1 and the back electrode plate 2 utilizing the spacer 8.

The diaphragm 1 is composed of the conductive vibrating membrane electrode 9 and a ring-shaped conductive frame body 10 configured to support the vibrating membrane electrode 9. The back electrode plate 2 is provided with an electret film 11 in such a manner that the electret film 11 faces the vibrating membrane electrode 9, and a plurality of through-holes 12 are formed, each penetrating both the back electrode plate 2 and the electret film 11.

The housing 7 configured to accommodate the capacitor portion 3 is composed of: the substrate 5 as bottom face member; a first intermediate member 13 and a second intermediate member 14 as intermediate member; and a top face member 15.

The substrate 5 is made of an insulating material (e.g., polyimide and glass epoxy), and though not shown, has a metal wiring pattern formed thereon. The converting circuit portion 4 is disposed on the substrate 5 while allowed to be connected with the metal wiring pattern. The converting circuit portion 4 is formed of an impedance converter (IC) capable of outputting an analog or digital signal.

As described above, the housing 7 includes the substrate 5, the first intermediate member 13, the second intermediate member 14 and the top face member 15, layered together.

The first intermediate member 13 is made of an insulating material (e.g., polyimide and glass epoxy) and is provided with the conduction portions 6 inside thereof. In addition, the first intermediate member 13 has: a tubular portion 13a formed in a rectangular shape as a planar view; and protruding portions 13b each inwardly protruding from the tubular portion 13a with intervals along a circumferential direction of the tubular portion 13a. In a tip end portion of the protruding portion 13b, the conduction portion 6 is disposed. The conduction portion 6 is electrically conductive with the back electrode plate 2 and also with a metal wiring pattern of the substrate 5. As a result, the conduction portion 6 allows electrical conduction between the capacitor portion 3 and the converting circuit portion 4.

The second intermediate member 14 is made of an insulating material (e.g., polyimide and glass epoxy) and mounted on the first intermediate member 13. The second intermediate member 14 is a ring-shaped member made of an insulating material, and a fit space into which the capacitor portion 3 is fitted is provided inwardly of the ring portion.

The top face member 15 is a member having an insulating property, and when layered with the second intermediate member 14, a layered body is in a recessed shape which closes an upside of the housing and opens downwardly. The top face member 15 also has two sonic holes.

As shown in FIGS. 1 and 2, a cuboidal condenser microphone is formed by, on the substrate 5 having the converting circuit portion 4 provided thereon, layering the first intermediate member 13, the back electrode plate 2, the spacer 8, the diaphragm 1, the second intermediate member 14 and the top face member 15 in this order. As a planar view, the substrate 5, the first intermediate member 13, the second intermediate member 14, and the top face member 15 are the same or approximately the same in size.

In the present embodiment, the frame body 10 of the diaphragm 1 is brought into contact with an inner face of the conductive top face member 15. Though not shown, each of the inner face of the top face member 15, the second intermediate member 14, the first intermediate member 13 and the substrate 5 (metal wiring pattern) has a conductive layer provided on a surface thereof, and these components are attached to one another in such a manner that each of them becomes conductive with the adjacent component. Alternatively, by disposing conductive members inside, or by attaching the components using a conductive adhesive, from the inner face of the top face member 15, through the second intermediate member 14 and the first intermediate member 13, to the substrate 5 (metal wiring pattern), the components become conductive. Therefore, the frame body 10 of the diaphragm 1 is electrically connected to the metal wiring pattern of the substrate 5 through the inner face of the top face member 15, the second intermediate member 14 and the first intermediate member 13, each being conductive. As a result, a capacitance change between the vibrating membrane electrode 9 and the back electrode plate 2, caused by vibration of the vibrating membrane electrode 9, is detected by the converting circuit portion 4.

As shown in FIG. 2, sound waves entered the internal space of the housing 7 from a sonic hole 15a advance through a route A and reach a front face, i.e., top face of the vibrating membrane electrode 9. In addition, in the present embodiment, since the back electrode plate 2 is provided with the through-hole 12, sound waves entered the internal space of the housing 7 from a sonic hole 15b advance through a route B and reach a back face, i.e., bottom face of the vibrating membrane electrode 9. In other words, the internal space of the housing 7 is partitioned into two: a space extending from the sonic hole 15a among a plurality of the sonic holes 15a,15b to one face (i.e., top face) of the vibrating membrane electrode 9; and a space extending from the other sonic hole 15b to the other face (i.e., bottom face) of the vibrating membrane electrode 9. Accordingly, one face of the vibrating membrane electrode 9 receives the sound waves passed through the sonic hole 15a, while the other face of the vibrating membrane electrode 9 receives the sound waves passed through the sonic hole 15b. In the present embodiment, the capacitor portion 3 accommodated in the housing 7 partitions the internal space of the housing 7.

In the condenser microphone according to the present embodiment, the sound waves emitted at a position equidistant from the sonic hole 15a and the sonic hole 15b reach the top and bottom faces of the vibrating membrane electrode 9 at substantially the same time, through the route A and the route B, respectively. Therefore, there can be obtained a condenser microphone in which the sound waves emitted at a position equidistant from the sonic hole 15a and the sonic hole 15b are cancelled at the vibrating membrane electrode 9: in other words, a bidirectional condenser microphone can be obtained that has a directional axis lying on a straight line connecting the sonic hole 15a and the sonic hole 15b. In addition, a plurality of the sonic holes can be formed in the same face of the housing 7, unlike the conventional technique that necessitates sonic holes on both top and bottom faces of the housing, and thus design freedom of an audio device having this condenser microphone mounted therein can be enhanced.

### Second Embodiment

The condenser microphone according to a second embodiment is different from the condenser microphone according to the first embodiment in that a covering member is provided that covers the top face member having the sonic holes. Hereinbelow, the condenser microphone according to the second embodiment will be described, wherein components which are the same as those illustrated in the first embodiment are designated with the same reference characters, and thus a duplicate description is omitted.

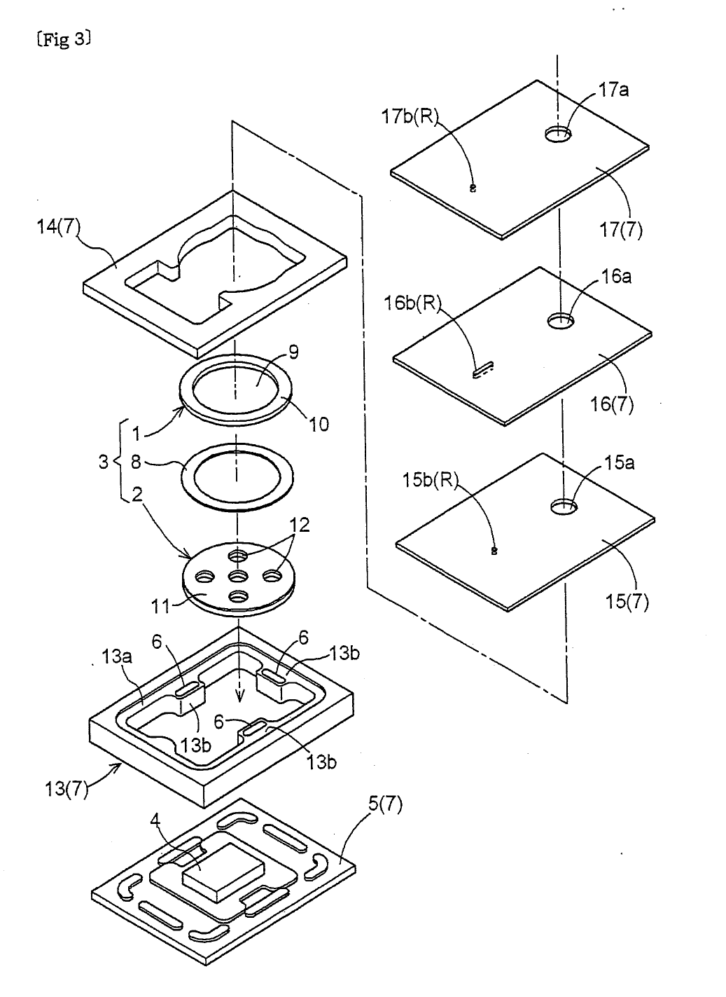

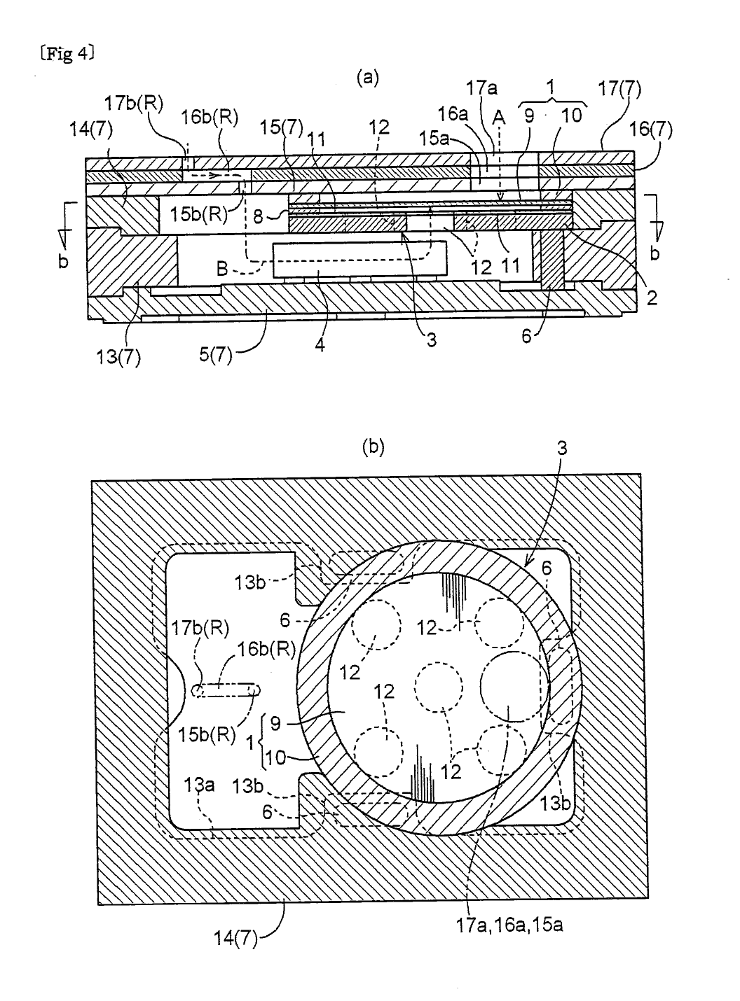

FIG. 3 is an exploded perspective view of the condenser microphone according to the second embodiment. FIG. 4(a) is a cross section of the condenser microphone according to the second embodiment. FIG. 4(b) is a top perspective view illustrating a state of the capacitor portion 3 accommodated inside the housing 7. As shown in FIGS. 3 and 4, in the present embodiment, on a front face side of the top face member 15, there are provided a first covering member 16 and a second covering member 17, layered in this order. The sonic hole 15a, a through-hole 16a and a through-hole 17a formed in the top face member 15, the first covering member 16 and the second covering member 17, respectively, are approximately the same in size and aligned with one another. Therefore, the sonic hole 15a, the through-hole 16a and the through-hole 17a do not narrow a cross section of a passage of the sound waves that pass through the route A and reach the vibrating membrane electrode 9.

On the other hand, a cross section of a passage of the sonic hole 15b is made smaller than the cross section of the passage of the sonic hole 15a. Further, a through-hole 16b formed in the first covering member 16 has a slit-like shape, and a through-hole 17b formed in the second covering member 17 is made smaller than the cross section of the passage of the sonic hole 15a, like the sonic hole 15b. One end of the slit-shaped through-hole 16b communicates with the through-hole 17b, while the other end communicates with the sonic hole 15b. Therefore, as shown in FIG. 4, sound waves entered from the through-hole 17b reach one end of the slit-shaped through-hole 16b, advance through the through-hole 16b, and from the other end of the through-hole 16b, reach the sonic hole 15b. Subsequently, the sound waves enter the internal space of the housing 7 from the sonic hole 15b. To put it another way, with respect to the portion from the through-hole 17b through the through-hole 16b to the sonic hole 15b, the cross section of the passage for the sound waves is made smaller and the passage is made longer, and thus the passage functions as a resistance means R which imparts resistance to the sound waves. Therefore, the resistance means R delays the sound waves entered from the through-hole 17b in reaching the vibrating membrane electrode 9.

As described above, the sound waves entered the internal space of the housing 7 through the through-hole 17a, the through-hole 16a and the sonic hole 15a advance through the route A and reach the front face, i.e., top face of the vibrating membrane electrode 9. In addition, the sound waves entered the internal space of the housing 7 through the through-hole 17b, the through-hole 16b and the sonic hole 15b advance through the route B and reach the back face, i.e., bottom face of the vibrating membrane electrode 9. In this case, the sound waves emitted at a position closer to the through-hole 17b than the through-hole 17a reach the top and bottom faces of the vibrating membrane electrode 9 at substantially the same time, through the route A and the route B, respectively. This is because the sound waves advancing through the route B are delayed in reaching the vibrating membrane electrode 9, due to an effect of the resistance means R. Therefore, there can be obtained a condenser microphone in which the sound waves emitted at a position closer to the through-hole 17b than the through-hole 17a are cancelled at the vibrating membrane electrode 9. On the other hand, when the sound waves emitted at a position closer to the through-hole 17a than the through-hole 17b, the sound waves advanced through the route A reach the vibrating membrane electrode 9 (front face thereof), ahead of the sound waves advanced through the route B. Therefore, a unidirectional condenser microphone can be obtained that has a directional axis lying on a straight line connecting the through-hole 17a and the through-hole 17b and has directionality toward the through-hole 17a.

### Third Embodiment

The condenser microphone according to a third embodiment is different from the condenser microphone according to the first embodiment in that a covering member is provided that covers the top face member having the sonic holes. Hereinbelow, the condenser microphone according to the third embodiment will be described, and with respect to each of components which are the same as those illustrated in the first embodiment, a duplicate description is omitted.

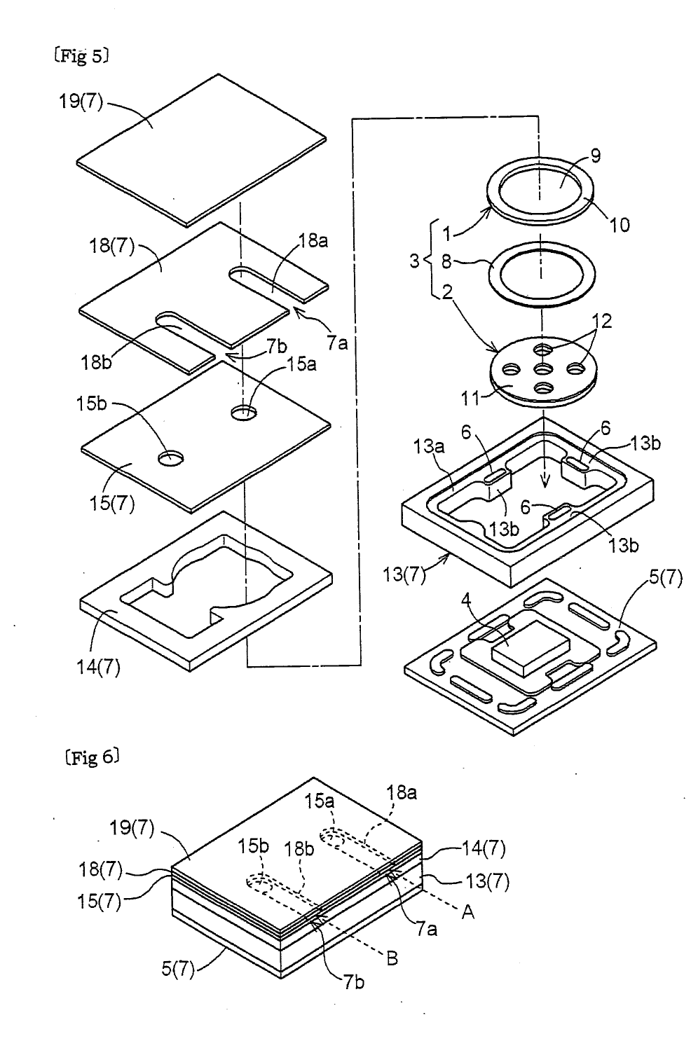

FIG. 5 is an exploded perspective view of the condenser microphone according to the third embodiment. FIG. 6 is a partial perspective view of the condenser microphone according to the third embodiment seen from obliquely above. As shown in FIGS. 5 and 6, in the present embodiment, on a front face side of the top face member 15, there are provided a first covering member 18 and a second covering member 19, layered in this order. The first covering member 18 is provided with two slits 18a,18b, each extending from a central area of the covering member 18 to one side of a rectangle. The slits 18a,18b communicate with the sonic hole 15a,15b of the top face member 15, respectively, from which the slits 18a, 18b extend to one side of the rectangle. There are no slits or holes formed in the second covering member 19. Accordingly, by layering the first covering member 18 and the second covering member 19 in this order on the top face member 15, there are formed vent passages to the sonic holes 15a,15b from openings 7a,7b, respectively, on a lateral face of the housing 7 formed by mounting the first covering member 18 and the second covering member 19. In other words, the slits 18a,18b function as vent passages that allow the sonic holes 15a,15b to communicate with a lateral face of the housing 7, respectively.

As described above, in the condenser microphone according to the present embodiment, the lateral face of the housing 7 is provided with the openings 7a,7b for introducing sound waves. Therefore, like the first embodiment, a bidirectional condenser microphone can be obtained that has a directional axis lying on a straight line connecting the opening 7a and the opening 7b. In the present embodiment, since the openings 7a,7b for introducing the sound waves to the internal space of the housing 7 are provided on the lateral side of the housing 7, when this condenser microphone is mounted inside an audio device, such as microphone device and mobile phone, freedom of mounting is enhanced.

### Fourth Embodiment

The condenser microphone according to a fourth embodiment is different from the condenser microphone according to the third embodiment in that two sonic holes are different in size. Hereinbelow, the condenser microphone according to the fourth embodiment will be described, and with respect to each of components which are the same as those illustrated in the third embodiment, a duplicate description is omitted.

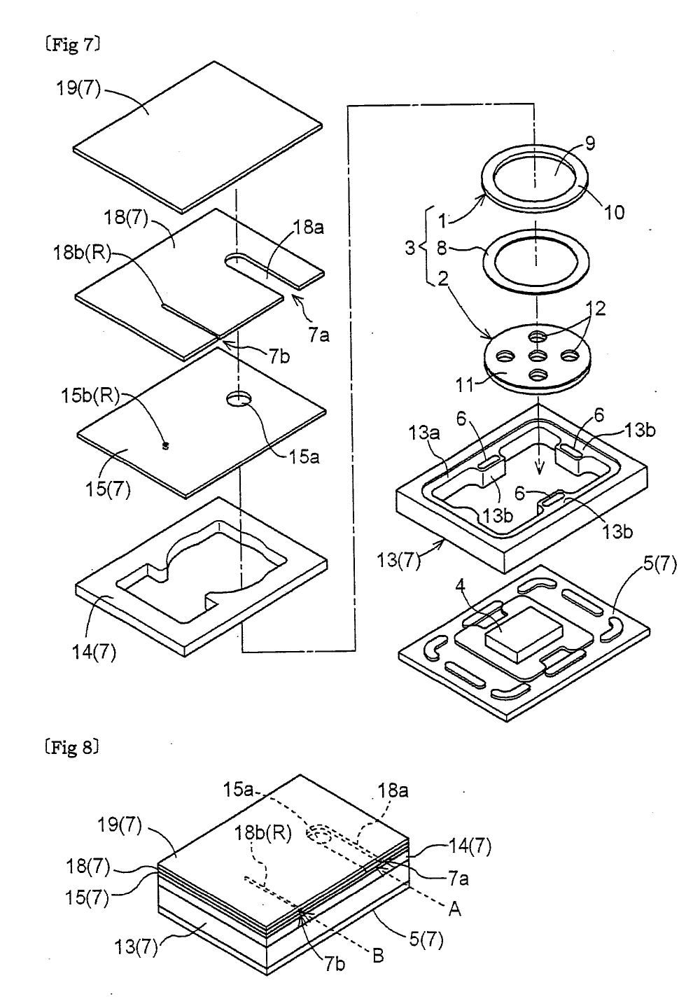

FIG. 7 is an exploded perspective view of the condenser microphone according to the fourth embodiment. FIG. 8 is a partial perspective view of the condenser microphone according to the fourth embodiment seen from obliquely above. As shown in FIGS. 7 and 8, in the present embodiment, the cross section of the passage of the sonic hole 15b is made smaller than the cross section of the passage of the sonic hole 15a. In accordance with this, a width of the slit 18b of the first covering member 18 is made smaller than that of the slit 18a. Therefore, a cross section of a passage for sound waves passing through the slit 18b and then entering the internal space of the housing from the sonic hole 15b become smaller than a cross section of a passage for sound waves passing through the slit 18a and then entering the internal space of the housing from the sonic hole 15a. In other words, the slit 18b and the sonic hole 15b serve as the resistance means R to the sound waves.

Therefore, in the present embodiment, a unidirectional condenser microphone can be obtained that has a directional axis lying on a straight line connecting the opening 7a and the opening 7b and has directionality toward the opening 7a.

### Fifth Embodiment

The condenser microphone according to a fifth embodiment is different from the condenser microphone according to the first embodiment in that sonic holes are formed in a substrate as bottom face member. Hereinbelow, the condenser microphone according to the fifth embodiment will be described, and with respect to each of components which are the same as those illustrated in the first embodiment, a duplicate description is omitted.

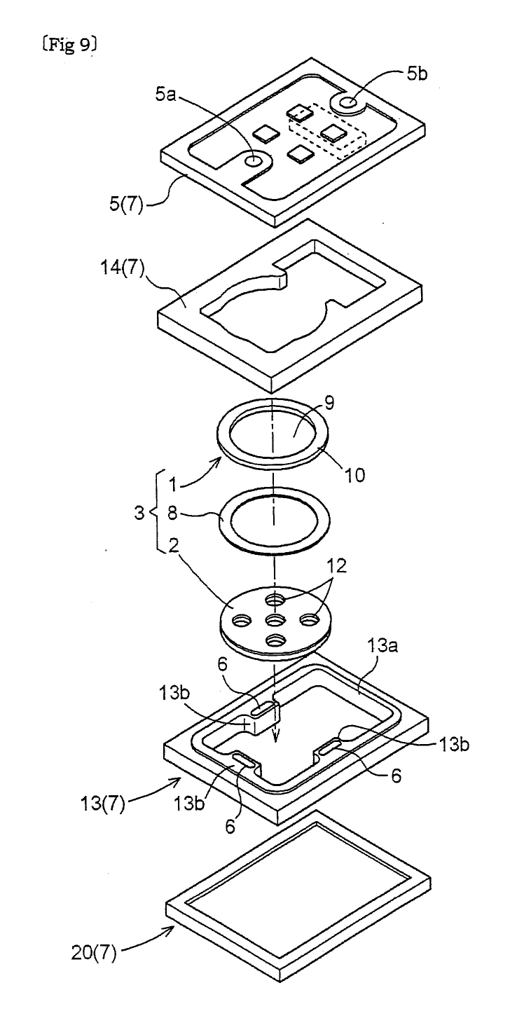

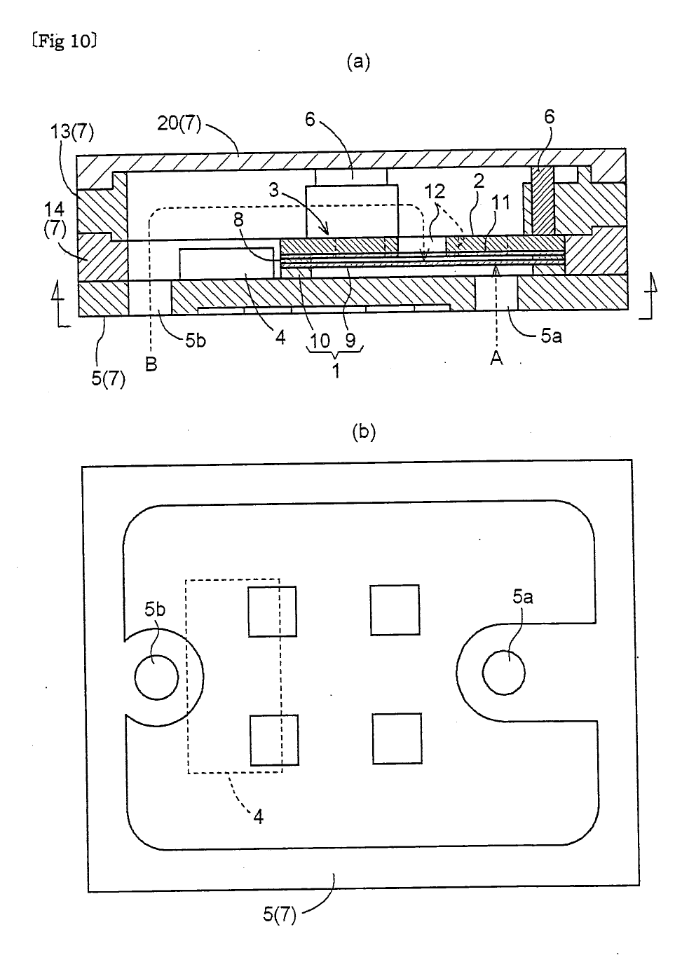

FIG. 9 is an exploded perspective view of the condenser microphone according to the fifth embodiment seen from a substrate 5 side. FIG. 10(a) is a cross section of the condenser microphone according to the fifth embodiment. FIG. 10(b) is a bottom view of the substrate 5. As shown in FIGS. 9 and 10, the condenser microphone according to the present embodiment is formed of the second intermediate member 14, the first intermediate member 13 and a top face member 20, layered in this order on the substrate 5 as bottom face member. The capacitor portion 3 is fitted into a fit space of the second intermediate member 14. In the present embodiment, the capacitor portion 3 is composed of the diaphragm 1, the spacer 8 and the back electrode plate 2, layered in this order from the substrate 5 side, and is formed as a capacitor by making a space between the diaphragm 1 and the back electrode plate 2 utilizing the spacer 8. By the conduction portion 6 of the first intermediate member 13, the back electrode plate 2 is pressed to the substrate 5 from above, to thereby bring the frame body 10 of the diaphragm 1 into contact with the substrate 5 and stabilize the capacitor portion 3 in the internal space of the housing 7.

As shown in FIG. 10, sound waves entered the internal space of the housing 7 from a sonic hole 5a advance through the route A and reach a back face, i.e., bottom face of the vibrating membrane electrode 9. In addition, in the present embodiment, since the back electrode plate 2 is provided with the through-hole 12, sound waves entered the internal space of the housing 7 from a sonic hole 5b advance through the route B and reach the front face, i.e., top face of the vibrating membrane electrode 9. In other words, the internal space of the housing 7 is partitioned into two: a space extending from the sonic hole 5a among a plurality of the sonic holes 5a,5b to one face (i.e., bottom face) of the vibrating membrane electrode 9; and a space extending from the other sonic hole 5b to the other face (i.e., top face) of the vibrating membrane electrode 9. Accordingly, one face of the vibrating membrane electrode 9 receives sound waves passed through the sonic hole 5a, while the other face of the vibrating membrane electrode 9 receives the sound waves passed through the sonic hole 5b. In the present embodiment, the capacitor portion 3 accommodated in the housing 7 partitions the internal space of the housing 7.

In this case, the sound waves emitted at a position equidistant from the sonic hole 5a and the sonic hole 5b reach the top and bottom faces of the vibrating membrane electrode 9 at substantially the same time, through the route A and the route B, respectively. Therefore, there can be obtained a condenser microphone in which sound waves emitted at a position equidistant from the sonic hole 5a and the sonic hole 5b are cancelled at the vibrating membrane electrode 9: in other words, a bidirectional condenser microphone can be obtained that has a directional axis lying on a straight line connecting the sonic hole 5a and the sonic hole 5b.

### Sixth Embodiment

The condenser microphone according to a sixth embodiment is different from the condenser microphone according to the fifth embodiment in that a covering member is provided that covers the bottom face member having the sonic holes. Hereinbelow, the condenser microphone according to the sixth embodiment will be described, and with respect to each of components which are the same as those illustrated in the fifth first embodiment, a duplicate description is omitted.

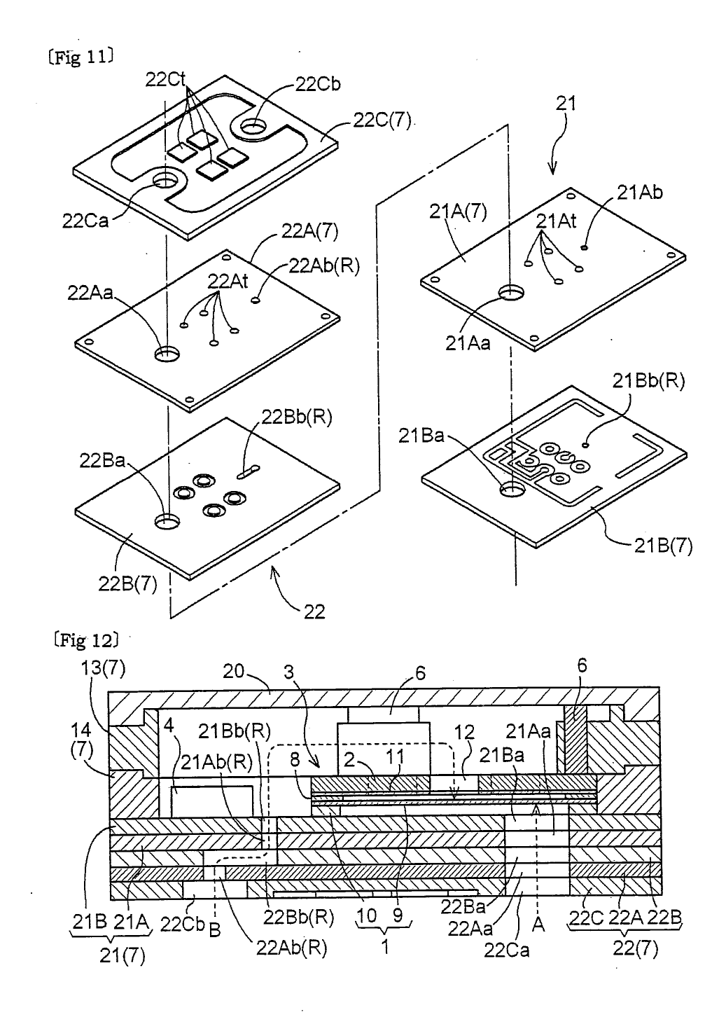

FIG. 11 is an exploded perspective view of the covering member and a portion of a substrate provided in the condenser microphone according to the sixth embodiment, and configurations of other components are omitted since they are the same as those illustrated in FIG. 9. FIG. 12 is a cross section of the covering member and the portion of the substrate provided in the condenser microphone according to the sixth embodiment. As shown in FIGS. 11 and 12, in the present embodiment, on an outer face side of a substrate 21 as bottom face member, a covering member 22 is layered. Like the substrate 5 described in the embodiment above, in the substrate 21, a copper foil 21B forming a metal wiring pattern is provided on one face of an insulating member 21A. The converting circuit portion 4 is disposed on the copper foil 21B (metal wiring pattern). The covering member 22 is provided so as to cover outside the substrate 21 as bottom face member, and formed of an insulating member 22A, a copper foil 22B provided on an inner face (on a substrate 21 side) of the insulating member 22A, and a copper foil 22C provided on an outer face of the insulating member 22A. Therefore, the converting circuit portion 4 formed on the copper foil 21B of the substrate 2 is conductive with terminals 22Ct exposed outside the copper foil 22C, through the copper foil 21B, through-holes 21At of the insulating member 21A, the copper foil 22B, and through-holes 22At of the insulating member 22A.

Through-holes 21Aa,21Ab provided in the insulating member 21A and through-holes 21Ba,21Bb provided in the copper foil 21B function as sonic holes for introducing sound waves to the internal space of the housing 7. In the present embodiment, the through-hole 21Aa and the through-hole 21Ba are approximately the same in size and aligned with each other, and likewise the through-hole 21Ab and the through-hole 21Bb are approximately the same in size and aligned with each other. A cross section of a passage of the through-hole 21Ab and the through-hole 21Bb is made smaller than a cross section of a passage of the through-hole 21Aa and the through-hole 21Ba.

With respect to the covering member 22, through-holes 22Aa,22Ba,22Ca formed in the insulating member 22A, the copper foil 22B and the copper foil 22C, respectively, are approximately the same in size and aligned with one another. In addition, in the insulating member 22A, a through-hole 22Ab is formed that is smaller than the through-hole 22Aa, and in the copper foil 22B, a slit-shaped through-hole 22Bb is formed that is smaller in width than the through-hole 22Ba. The through-hole 22Ca and a through-hole 22Cb formed in the copper foil 22C locating outermost of the covering member 22 are approximately the same in size.

One end of the slit-shaped through-hole 22Bb formed in the copper foil 22B as one component of the covering member 22 communicates with the through-hole 21Ab of the insulating member 21A as one component of the substrate 21, while the other end of the through-hole 22Bb communicates with the through-hole 22Ab of the insulating member 22A as one component of the covering member 22.

As indicated with the route A in FIG. 12, the cross section is nearly constant with respect to the passage for sound waves entered the inside of the housing 7 through the through-holes 22Ca,22Aa, 22Ba, 21Aa and 21Ba.

On the other hand, as indicated with the route B in FIG. 12, with respect to the passage for sound waves entered the inside of the housing 7 through the through-holes 22Cb, 22Ab, 22Bb, 21Ab and 21Bb, the cross section is smaller than that of the passage for the sound waves advancing through the route A. In addition, the route B has a longer passage than the route A. In other words, a portion of the route B from the through-hole 22Ab to the through-hole 21Bb functions as the resistance means R which imparts resistance to the sound waves. Therefore, the resistance means R delays the sound waves entered from the through-hole 22Cb in reaching the vibrating membrane electrode 9.

As described above, the sound waves entered the internal space of the housing 7 through the through-holes 22Ca, 22Aa, 22Ba, 21Aa and 21Ba advance through the route A and reach the back face, i.e., bottom face of the vibrating membrane electrode 9. In addition, the sound waves entered the internal space of the housing 7 through the through-holes 22Cb, 22Ab, 22Bb, 21Ab and 21Bb advance through the route B and reach the front face, i.e., top face of the vibrating membrane electrode 9. In this case, the sound waves emitted at a position closer to the through-hole 22Cb than the through-hole 22Ca both locating on the outer side of the housing 7 reach the top and bottom faces of the vibrating membrane electrode 9 at substantially the same time, through the route A and the route B, respectively. This is because the sound waves advancing through the route B are delayed in reaching the vibrating membrane electrode 9, due to an effect of the resistance means R. Therefore, there can be obtained a condenser microphone in which the sound waves emitted at a position closer to the through-hole 22Cb than the through-hole 22Ca are cancelled at the vibrating membrane electrode 9. On the other hand, when the sound waves emitted at a position closer to the through-hole 22Ca than the through-hole 22Cb, the sound waves advanced through the route A reach the vibrating membrane electrode 9 (bottom face thereof), ahead of the sound waves advanced through the route B. Therefore, a unidirectional condenser microphone can be obtained that has a directional axis lying on a straight line connecting the through-hole 22Ca and the through-hole 22Cb and has directionality toward the through-hole 22Ca.

### Other Embodiments

### 1

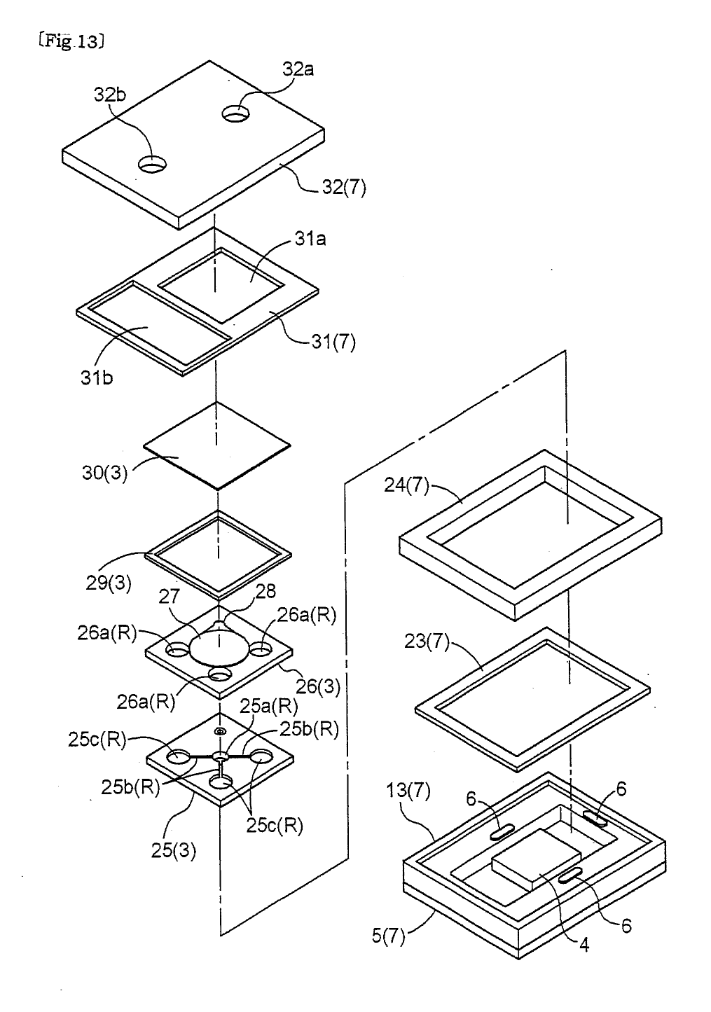

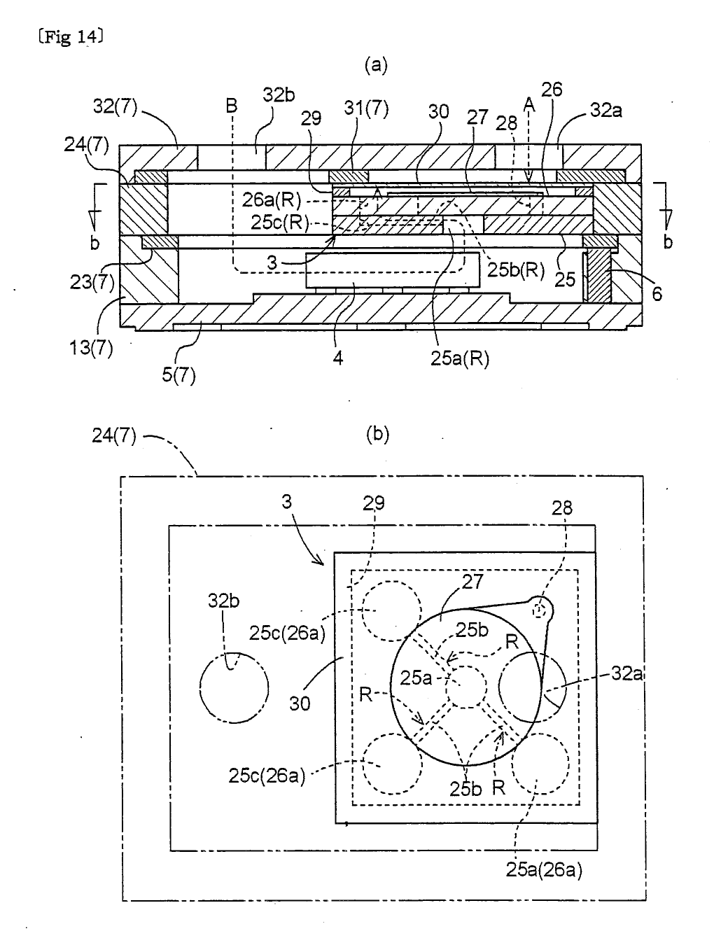

In the embodiment described above, each component of the condenser microphone may be modified to have other shapes. FIG. 13 is an exploded perspective view of the condenser microphone according to another embodiment. FIG. 14(a) is a cross section of the condenser microphone according to this embodiment. FIG. 14(b) is a top perspective view illustrating a state of the capacitor portion 3 accommodated inside the housing 7. As shown in FIGS. 13 and 14, the condenser microphone is composed of the first intermediate member 13 as intermediate member, a first conductive member 23, a second intermediate member 24, a second conductive member 31, and a top face member 32, layered in this order on the substrate 5 as bottom face member. In addition, the capacitor portion 3 is formed of a conductive layer 25, a back electrode member 26, a spacer 29 and a vibrating membrane electrode 30, layered in this order from the substrate 5 side.

The conductive layer 25 as a part of the capacitor portion 3 has a through-hole 25a penetrating a center portion of the conductive layer 25, from a substrate side to a top face side. On the top face side of the conductive layer 25, grooves 25b are formed each of which extends from the central through-hole 25a to the corresponding corner, where a circular recess 25c is formed that communicates with the corresponding groove 25b.

In the back electrode member 26 to be layered above the conductive layer 25, a circular through-hole 26a is formed at a position aligning with the corresponding circular recess 25c. In addition, on a top face of the back electrode member 26, a conductive back electrode 28 as fixed electrode and an electret film 27 are sequentially formed. On the top face of the back electrode member 26, the spacer 29 is provided, and a top face of the spacer 29 is provided with the vibrating membrane electrode 30. Therefore, the conductive vibrating membrane electrode 30 faces the electret film 27 with the spacer 29 sandwiched therebetween.

The second conductive member 31 provided on a top face of the capacitor portion 3 has rectangular openings 31a and 31b. A frame portion having the opening 31a is brought into contact with a periphery portion of the vibrating membrane electrode 30, and presses the vibrating membrane electrode 30 to a bottom face side.

In this condenser microphone, the back electrode 28 is electrically conductive with the conduction portion 6 of the first intermediate member 13 through the conductive layer 25, and further with the converting circuit portion 4 of the substrate 5. In addition, the vibrating membrane electrode 30 is grounded through the second conductive member 31, the second intermediate member 24, and the first conductive member 23. As a result, a capacitance change between the vibrating membrane electrode 30 and the back electrode 28, caused by vibration of the vibrating membrane electrode 30, is detected by the converting circuit portion 4.

Sound waves entered the internal space of the housing 7 from a sonic hole 32a formed in the top face member 32 pass through the opening 31a of the second conductive member 31 (i.e., advance through the route A) and reach a top face of the vibrating membrane electrode 30. In addition, sound waves entered the internal space of the housing from a sonic hole 32b cannot reach the top face of the vibrating membrane electrode 30, but pass through the through-hole 25a, the groove 25b and the circular recess 25c formed in the conductive layer 25, and then the through-hole 26a of the back electrode member 26 (i.e., advance the route B) and reach a bottom face of the diaphragm. In other words, the internal space of the housing 7 is partitioned into two: a space extending from the sonic hole 32a among a plurality of the sonic holes 32a,32b to one face (i.e., top face) of the vibrating membrane electrode 30; and a space extending from the other sonic hole 32b to the other face (i.e., bottom face) of the vibrating membrane electrode 30. Accordingly, one face of the vibrating membrane electrode 30 receives the sound waves passed through the sonic hole 32a, while the other face of the vibrating membrane electrode 30 receives the sound waves passed through the sonic hole 32b. In the present embodiment, the capacitor portion 3 accommodated in the housing 7 and the second conductive member (intermediate member) 31 disposed between the top face member 32 and the capacitor portion 3 partition the internal space of the housing 7.

Herein, a portion where the sound waves entered the internal space of the housing 7 from the sonic hole 32b pass through (i.e., the through-hole 25a, the groove 25b and the circular recess 25c formed in the conductive layer 25 as well as the through-hole 26a of the back electrode member 26) is made in such a manner that the passage for the sound waves has a smaller cross section and a larger length, so as to function as the resistance means R which imparts resistance to the sound waves. Therefore, like the embodiments described above, this condenser microphone serves as a unidirectional microphone having directionality toward the sonic hole 32a.

### 2

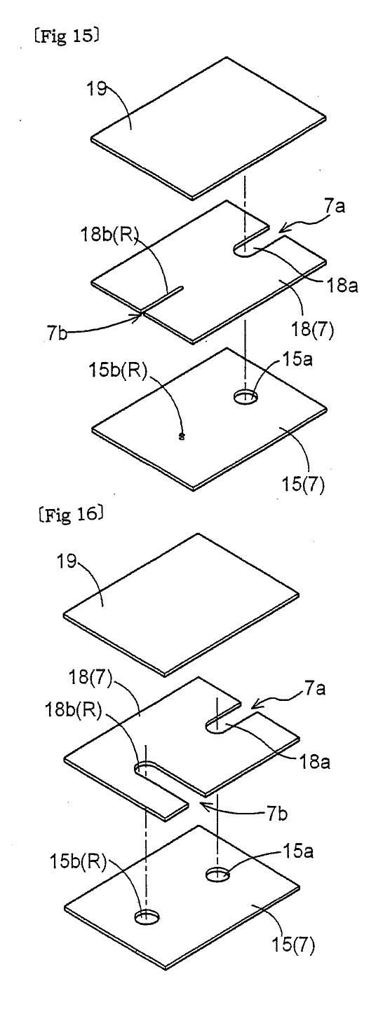

In the third and fourth embodiments, a case where the openings 7a,7b are provided on the same side of the housing 7 is described. Alternatively, the openings 7a,7b may be provided on different lateral faces. FIG. 15 illustrates a modified version of the condenser microphone shown in FIG. 7, in which only configurations of the covering members 18,19 and the top face member 15 are shown. The condenser microphone shown in FIG. 15 is one example in which the openings 7a,7b are formed in respective lateral faces of the housing 7 parallelly arranged on the opposite sides. In this case, a unidirectional condenser microphone can be obtained that has a directional axis lying on a straight line connecting the opening 7a and the opening 7b, and has directionality toward the opening 7a.

FIG. 16 illustrates a modified version of the condenser microphone shown in FIG. 5, in which only configurations of the covering members 18,19 and the top face member 15 are shown. The condenser microphone shown in FIG. 16 is one example in which the openings 7a,7b are formed in respective lateral faces of the housing 7 orthogonally arranged and thus adjacent to each other. In this case, a unidirectional condenser microphone can be obtained that has a directional axis lying on a straight line connecting the opening 7a and the opening 7b, and has directionality toward the opening 7a.

As described above, by altering the position of the sonic hole (opening) for introducing the sound waves to the internal space of the housing 7, the directional axis of the condenser microphone can be adjusted.

### 3

In the embodiment and other embodiments described above, configurations of the housing, the capacitor portion or the like may be appropriately modified. For example, there may be used a capacitor portion which does not have an electret film and a capacitor is formed by applying a voltage between the vibrating membrane electrode and the fixed electrode from an external power source. Alternatively, the capacitor portion may be formed by a technology of micro-electro-mechanical system (MEMS).

The number of the sonic hole is not limited, and three or more holes may be provided. In addition, a plurality of the sonic holes may be imparted with acoustic resistance. For example, four sonic holes are provided in such a manner that sound waves passed through two of the sonic holes (sonic holes of a first group) reach one face of the vibrating membrane electrode, and sound waves passed through the other two sonic holes (sonic holes of a second group) reach the other face of the vibrating membrane electrode and further, resistance means which imparts resistance to the sound waves passing through said other two sonic holes may be provided. It should be noted that, in order to obtain a condenser microphone having directionality, it is preferred that a plurality of the sonic holes of the first group are formed in proximity to one another and a plurality of the sonic holes of the second group are formed in proximity to one another, while a plurality of the sonic holes of the first group and a plurality of the sonic holes of the second group are located at some distance to each other.

One example of the resistance means R for imparting the condenser microphone with unidirectionality was described above, and alternatively, the configuration of the resistance means R can be appropriately modified. For example, when the directional characteristics of the capacitor is to be modified by altering the resistance characteristics of the resistance means R descried above, shapes and sizes of the through-hole, sonic hole, slit and the like composing the resistance means R, as well as the size of the top face member, substrate (bottom face member) and intermediate member, can be appropriately changed. Specifically, in the condenser microphone illustrated in FIGS. 1 to 3, the resistance means R may be provided simply by reducing the cross section of the passage of the sonic hole 15b. Alternatively, an acoustic resistance film may be used as the resistance means R. For example, by covering the sonic hole 15b illustrated in FIG. 1 with the acoustic resistance film, resistance can be imparted to sound waves entered the internal space of the housing 7 from the sonic hole 15b.

### 4

In the embodiments above, by bringing the capacitor portion 3 into contact with the top face member or the bottom face member (substrate), i.e., by the capacitor portion 3, the internal space of the housing 7 is partitioned into two spaces: a space extending from a sonic hole(s) among a plurality of the sonic holes to one face of the vibrating membrane electrode; and a space extending from the other sonic hole(s) to the other face of the vibrating membrane electrode. Alternatively, the internal space of the housing 7 may be partitioned using still another intermediate member. For example, between the capacitor portion 3 and the top face member or bottom face member, another member is provided (e.g., the second conductive member as intermediate member illustrated in FIGS. 13 and 14), and the internal space of the housing 7 may be partitioned by the capacitor portion and the member other than the capacitor portion.

### INDUSTRIAL APPLICABILITY

By mounting the condenser microphone according to the present invention inside an audio device, such as microphone device and mobile phone, an audio device having directionality can be obtained. In addition, since the position in the condenser microphone at which sound waves are introduced can be set as desired, design freedom of an audio device having this condenser microphone mounted therein will not be restricted.

1. A condenser microphone having, inside a housing, a vibrating membrane electrode configured to vibrate in response to sound waves entered an internal space of the housing and a fixed electrode, the condenser microphone comprising:
a capacitor portion formed of the vibrating membrane electrode and the fixed electrode;
a converting circuit portion configured to convert a change in capacitance of the capacitor portion into an electrical signal and to output the signal; and
a conduction portion configured to allow electrical conduction between the capacitor portion and the converting circuit portion,
wherein
the housing comprises a combination of: a top face member forming a top face; a bottom face member forming a bottom face; and an intermediate member disposed between the top face member and the bottom face member;
the top face member or the bottom face member is provided with a plurality of sonic holes configured to allow a sound to enter the internal space, and
the internal space of the housing is partitioned into a space extending from one or more sonic holes among said plurality of the sonic holes to one face of the vibrating membrane electrode and a space extending from the other one or more sonic holes among said plurality of the sonic holes to the other face of the vibrating membrane electrode.

2. The condenser microphone according to claim 1, wherein
a covering member is attached to the housing so as to cover the top face member or the bottom face member provided with said plurality of the sonic holes, and
each of said plurality of the sonic holes is provided with a vent passage from a lateral face of the housing to which the covering member is attached.

3. The condenser microphone according to claim 1 or 2, wherein resistance means is provided which imparts resistance to sound waves passing through said other one or more sonic holes.

4. The condenser microphone according to claim 3, wherein the resistance means is formed by making a cross section of a passage of sound waves that pass through said other one or more sonic holes smaller.

5. The condenser microphone according to claim 4, wherein the resistance means is formed by making a passage of sound waves that pass through said other one or more sonic holes longer.
